(19) United States
(12) Patent Application Publication
(10) Pub. No.: US 2018/0039978 A1
(43) Pub. Date: Feb. 8, 2018

(54) GIFT-TRANSFER SYSTEM

(71) Applicant: HALLMARK CARDS, INCORPORATED, KANSAS CITY, MO (US)

(72) Inventor: SCOTT A. SCHIMKE, LEAVENWORTH, KS (US)

(21) Appl. No.: 15/227,779

(22) Filed: Aug. 3, 2016

(51) Int. Cl. G06Q 20/32; H04L 29/08; G06Q 20/34; H04W 4/00

(52) U.S. Cl. CPC G06Q 20/3278; H04W 4/003; H04L 67/02; G06Q 20/3567

(57) ABSTRACT

An aspect of the present invention includes a physical gift item that is constructed to include an NFC tag. By scanning the NFC tag, a gift-transfer application can be launched, which allows a user to select a digital gift and associate the digital gift with the NFC tag. The physical gift item can be given to another user, who can also scan the NFC tag in order to retrieve the digital gift.

### TECHNICAL FIELD

This disclosure describes using a near-field-communication tag (NFC tag) to access a gift-transfer system for electronically transferring a digital gift.

### BACKGROUND

Sometimes people choose to give money as a gift to another person, such as by giving the person cash, a check, or a gift card. But, these options can be less personal than a greeting card or other gift item.

### SUMMARY

An aspect of the present invention includes a physical gift item that is constructed to include an NFC tag. By scanning the NFC tag, a gift-transfer application can be launched, which allows a user to select a digital gift and associate the digital gift with the NFC tag. The physical gift item can be given to another user, who can also scan the NFC tag in order to retrieve the digital gift.

Some aspects of the invention are defined by the claims below, not this summary. A high-level overview of various aspects of the invention is provided here to introduce a selection of concepts that are further described below in the detailed-description section. This summary is not intended to identify key or essential features of the claimed subject matter, nor is it intended to be used as an aid in isolation to determine the scope of the claimed subject matter.

### BRIEF DESCRIPTION OF THE DRAWINGS

Illustrative embodiments of the present invention are described in detail below with reference to the attached drawing figures, which are incorporated herein by reference, wherein:

FIG. 1 depicts an illustrative environment in which some aspects of the present invention may be carried out or practiced in accordance with an embodiment of the present invention;

FIGS. 2A and 2B depict exemplary greeting cards that are constructed to include NFC tags in accordance with some embodiments of the present invention;

FIG. 3 depicts another type of physical gift item in accordance with an embodiment of the present invention;

FIG. 4 depicts a computing device running a gift-transfer software application in accordance with an embodiment of the present invention;

FIGS. 5A-5C depict respective components of the gift-transfer software application in accordance with some embodiments of the present invention;

FIG. 6 depicts some components of a gift-transfer service in accordance with an embodiment of the present invention;

FIG. 7 depicts a schematic ping diagram illustrating interaction between various components in accordance with an embodiment of the present invention; and

FIG. 8 depicts a generic computing device in accordance with an aspect of the present invention.

### DETAILED DESCRIPTION

The subject matter of this disclosure is described with specificity herein to meet statutory requirements. But, the description itself is not intended to necessarily limit the scope of claims. Rather, the claimed subject matter might be embodied in other ways to include different elements or combinations of elements similar to the ones described in this document, in conjunction with other present, or future, technologies. Terms should not be interpreted as implying any particular order among or between various steps herein disclosed unless, and except, when the order of individual steps is explicitly claimed.

At a high level, this disclosure describes a system that allows a person (“gift sender”) to electronically transfer a digital gift (also sometimes referred to as an “e-gift”) to another person (“gift recipient”). A digital gift may take various forms, and some examples of digital gifts include electronic funds (e.g., deposited to an account) or a digital experience (e.g., e-card, digital video, digital audio, digital image, etc.). In order to electronically transfer the digital gift, the gift sender can access a gift-transfer software application (e.g., mobile application or web application) by using his or her mobile device to scan a near-field-communication tag (NFC tag) constructed into a physical gift item, such as a greeting card, toy, and the like. Using the gift-transfer software application, the gift sender can associate the digital gift with the NFC tag. The gift sender can then give the physical gift item to the gift recipient, and the gift recipient can access the digital gift by scanning the NFC tag with his or her own mobile device. In some instances, the gift sender may receive a notification that the gift recipient has used the digital gift.

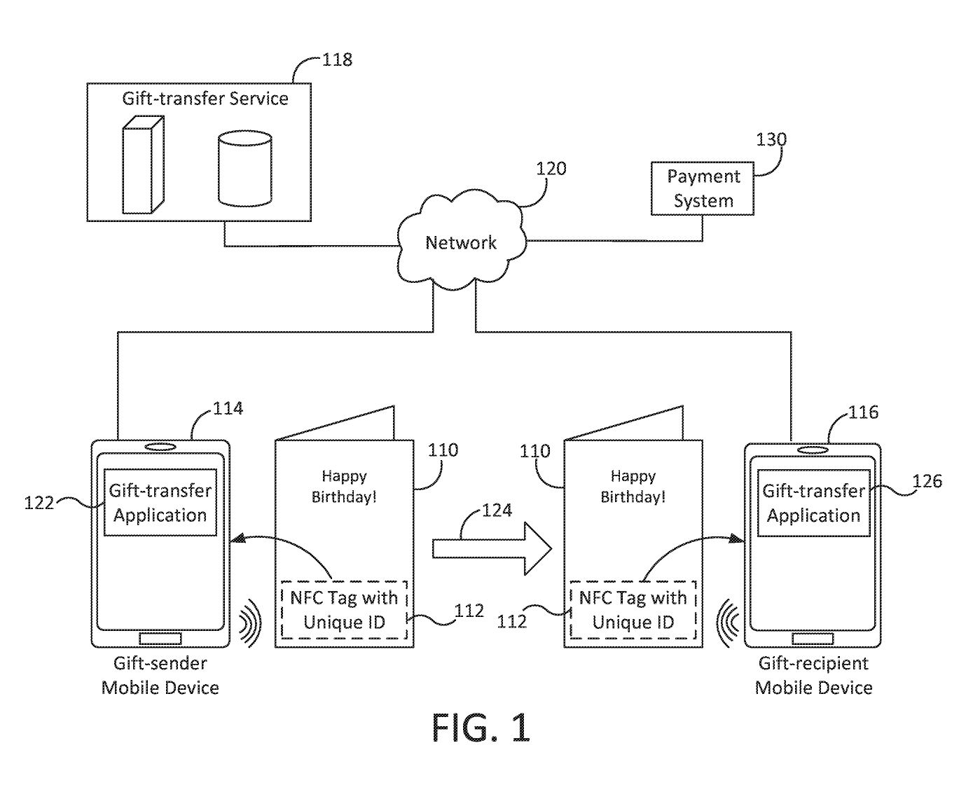

Referring now to FIG. 1, an illustrative environment is depicted in which various aspects of this disclosure may be practiced or carried out. As can be seen, FIG. 1 includes a physical gift item 110 that is constructed to include an NFC tag 112, which includes a unique NFC-tag identifier. In addition, FIG. 1 depicts a gift-sender mobile device 114, a gift-recipient mobile device 116, and a gift-transfer service 118 that communicates with the mobile devices 114 and 116 by way of a network 120 (e.g., PAN, WAN, LAN, MAN, and the like). FIG. 1 also depicts a payment system 130 that helps facilitate payment for a digital gift transferred from the gift sender to the gift recipient.

In accordance with an aspect of the disclosure, the gift-sender mobile device 114 scans the NFC tag 112 to receive both the unique NFC-tag identifier and computer-executable instructions for opening a first gift-transfer application 122. The gift-transfer application 122 can be used to associate a digital gift with the unique NFC-tag identifier and to communicate the association to the gift-transfer service 118. The gift-transfer service 118 stores a record of the association between the unique NFC-tag identifier and the digital gift, and the payment system 130 facilitates payment for the digital gift by an account specified using the first gift-transfer application 122.

The physical gift item 110, which includes the NFC tag 112, can be given to a gift recipient, as illustratively depicted by an arrow 124. The gift-recipient mobile device 116 scans the NFC tag 112 to retrieve the unique NFC-tag identifier, and a second gift-transfer application 126 may use the unique NFC-tag identifier to retrieve the digital gift from the gift-transfer service 118. Having generally described some of the features of this disclosure, each of the components will now be described in greater detail with reference to some of the other figures.

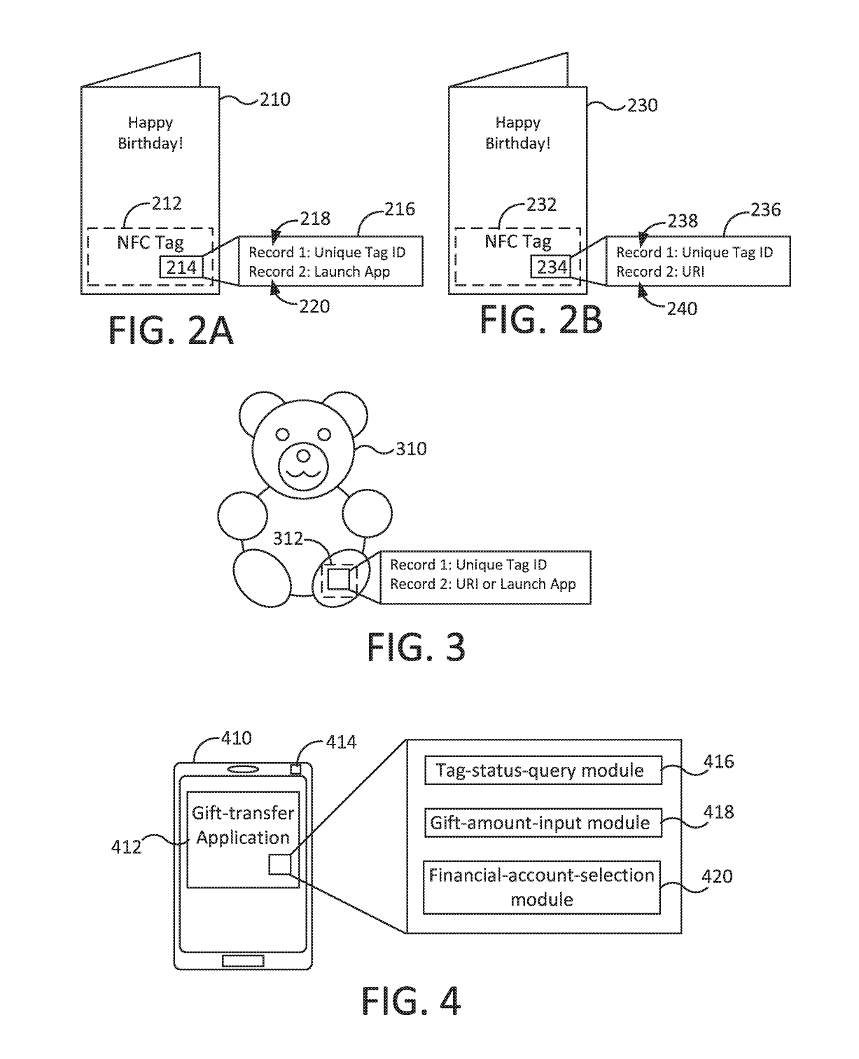

In FIG. 1, the physical gift item 110 is illustratively depicted as a greeting card, and FIGS. 2A and 2B provide two additional illustrative depictions of greeting cards 210 and 230. However, a greeting card is only one example of a physical gift item 110. A physical gift item 110 may include a variety of other hard goods or soft goods that can be constructed to include an NFC tag. For example, FIG. 3 depicts a toy bear 310 with an NFC tag 312 embedded therein, which operates similarly to the NFC tags 122, 212, and 232.

In accordance with an aspect of the disclosure, the physical gift item 110 is constructed to include the NFC tag 112, and as previously explained, the NFC tag 112 is encoded to include a unique NFC-tag identifier. In FIG. 2A, the greeting card 210 includes an NFC tag 212 with memory 214, such as a microchip. For example, the NFC tag 212 may be affixed (e.g., adhered, bonded, etc.) to at least one of the panels of the greeting card 210. The memory 214 stores data, and the magnified view 216 illustrates some illustrative stored data. The magnified view 216 includes a first set of stored data 218 that includes a unique NFC-tag identifier that uniquely identifies the NFC tag 212. In addition, the magnified view 216 depicts a second set of stored data 220 that includes computer-executable instructions for opening a gift-transfer application, such as the gift-transfer applications 122 and 126 depicted in FIG. 1. In one aspect of the present disclosure, the second set of stored data 220 includes computer-executable instructions that, when executed by a computing device (e.g., mobile device), open the gift-transfer application. For example, if the gift-transfer application is a mobile application, the computer-executable instructions might trigger an operating system of the computing device to launch or start the gift-transfer application that has been downloaded to the mobile device, as suggested by the text “Launch App” in FIG. 2A. Or, if the gift-transfer application is a mobile application that has not yet been downloaded to the computing device, the computer-executable instructions might trigger the operating system to open a “store” at which the mobile application can be downloaded.

Referring to FIG. 2B, the greeting card 230 also includes an NFC tag 232 with memory 234. Similar to the memory 214 in FIG. 2A, the memory 234 in FIG. 2B also stores a first set of stored data 238 that includes a unique NFC-tag identifier that uniquely identifies the NFC tag 232. In addition, the magnified view 236 depicts a second set of stored data 240 that includes computer-executable instructions for opening a gift-transfer application, such as the gift-transfer applications 122 and 126 depicted in FIG. 1. In one aspect of the present disclosure, the second set of stored data 240 includes computer-executable instructions that, when executed by a computing device (e.g., mobile device), open the gift-transfer application. For example, if the gift-transfer application is a web application, the computer-executable instructions might trigger a browser of the computing device to request a webpage, as suggested by the text “URI” in FIG. 2B.

Referring now to FIG. 4, an exemplary mobile device 410 is depicted that is running a gift-transfer application 412, which may be opened in response to the mobile device 410 scanning an NFC tag (e.g., 112, 212, 232) constructed into a physical gift item. The mobile device 410 may be a variety of different types of computing devices that can scan, and receive a transmission of data from an NFC tag. Examples of mobile devices include a cellphone or “smart” phone, a tablet computing device, a “smart” watch or other wearable computing device, a laptop, and the like. These examples of mobile devices are provided as context for one environment in which aspects of the disclosure might be practiced or carried out, and the examples are not meant to provide an exhaustive list. Rather, it is understood that aspects of this technology could be practiced or carried out with various other types of computing devices that could scan, and receive a transmission of data from, an NFC tag.

The mobile device 410 includes an NFC chip 414 configured to receive a transmission of data from an NFC tag (e.g., tags 112, 212, and 232). In addition, the mobile device 410 includes the gift-transfer application 412, which includes a software application programmed to perform various functions described in this application. As described in other parts of this disclosure, data that is transmitted from the NFC tag to the mobile device includes computer-executable instructions that, when executed by the mobile device 410, cause the mobile device 410 to launch, open, or start the gift-transfer application 412.

The gift-transfer application 412 may be a mobile application or a web application. The gift-transfer application 412 includes various programmed components that are useful to perform operations of the gift-transfer application 412 that facilitate transfer of a digital gift or e-gift. For example, FIG. 4 depicts that the gift-transfer application 412 includes a tag-status-query module 416, a digital-gift-input module 418, and a financial-account-selection module 420. This disclosure may describe the gift-transfer application 412 as having “a copy” or “copies,” which refers to a distinct copy of the gift-transfer application being downloaded to each mobile device. Each copy of the gift-transfer application may have the same components, and these components may be used in different manners depending on whether the gift-transfer application is being used to send a digital gift or to receive a digital gift.

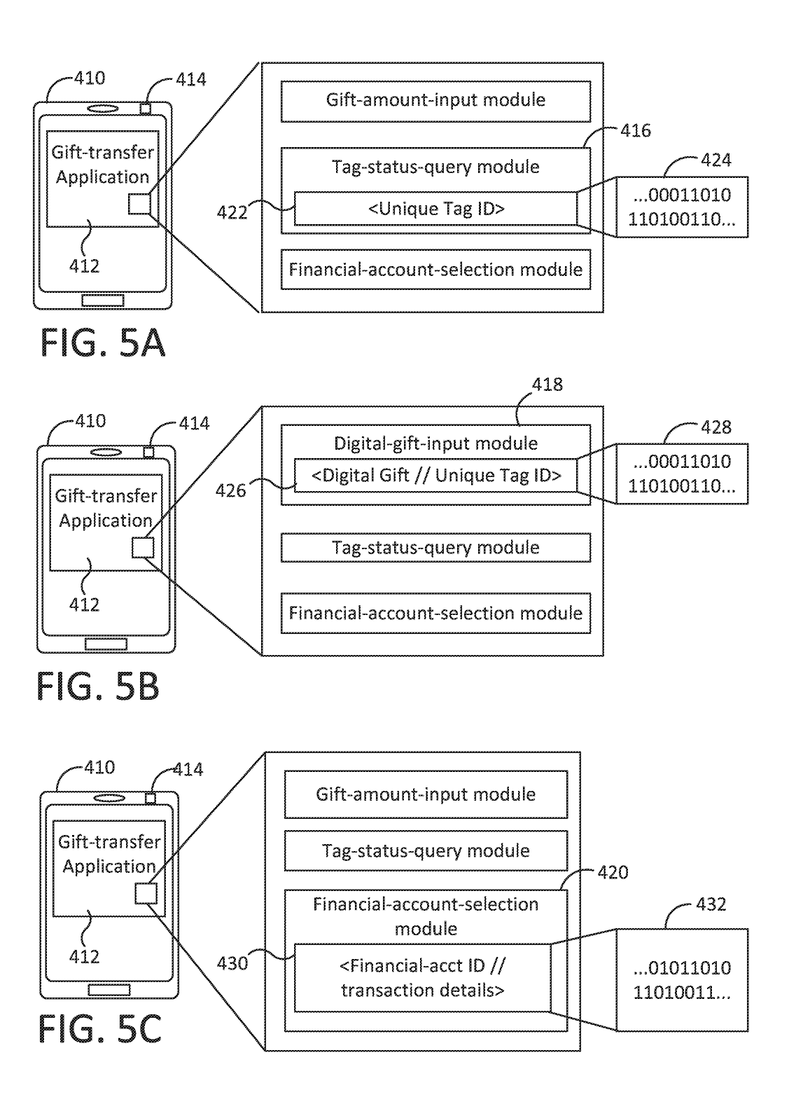

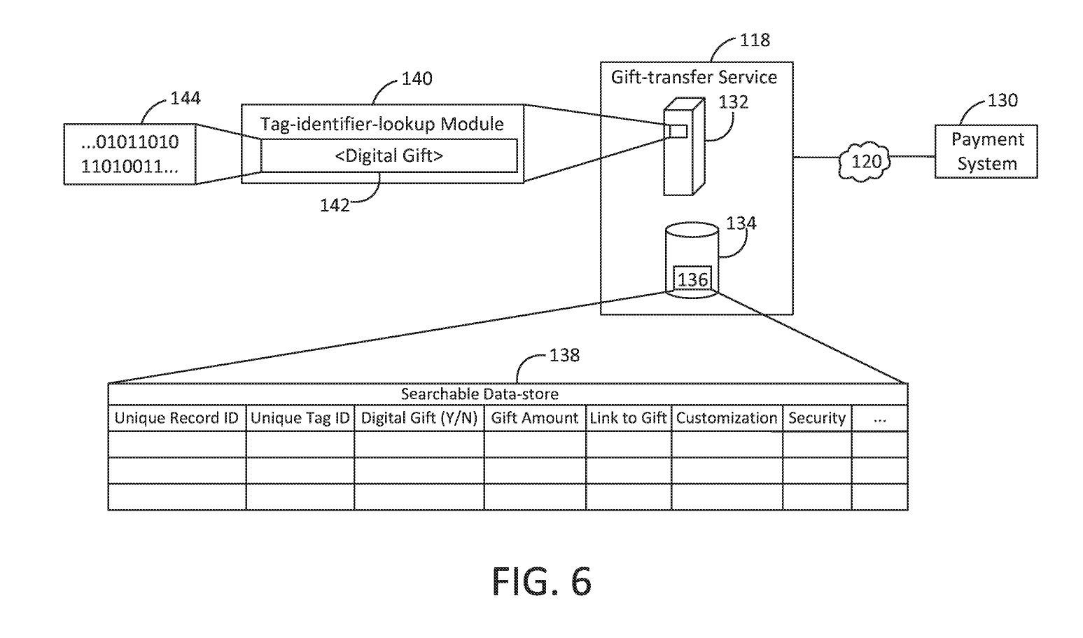

Referring now to FIGS. 5A-5C the tag-status-query module 416, the digital-gift-input module 418, and the financial-account-selection module 420 are depicted with additional details. The tag-status-query module 416 is configured to communicate with the gift-transfer service 118 (see e.g., FIGS. 1 and 6) to determine whether a digital gift has been associated with a unique NFC-tag identifier. For example, the tag-status-query module 416 receives the unique NFC-tag identifier that is transmitted from the NFC tag constructed into the physical gift item. In addition, the tag-status-query module 416 generates or produces a tag-query communication 422 (e.g., interprocess communication) that includes the unique NFC-tag identifier and that is transmitted to the gift-transfer service 118. In this sense, the tag-status-query module 416 may generate an electronic communication that did not previously exist, or modify a pre-existing communication, by generating or modifying underlying code 424 that makes up the communication 422.

The tag-status-query module 416 might be invoked by both the gift-transfer application running on the gift-sender mobile device and the gift-transfer application running on the gift-recipient mobile device. For example, by executing the tag-status-query module on the gift-sender mobile device, the gift-transfer application can confirm that no digital gift has been associated with a particular NFC tag and that the process should proceed with allowing a user to select a digital gift to be associated with the NFC tag. In addition, by executing the tag-status-query module on the gift-recipient mobile device, the gift-transfer application can determine that a digital gift has been associated with a particular NFC tag and can proceed with allowing the gift recipient to receive the digital gift.

The gift-transfer service 118, which maintains a record of unique NFC-tag identifiers, can look up the unique NFC-tag identifier when the gift-transfer service 118 receives the communication 422. The gift-transfer service 118 can then provide a responsive communication indicating to the gift-transfer application 412 whether the unique NFC-tag identifier is associated with a digital gift. Depending on whether a digital gift has been associated with the unique NFC-tag identifier, various actions can be taken using the gift-transfer application, such as progressing through a digital-gift selection process or allowing a financial account to be selected to receive a credit of the digital gift.

Referring to FIG. 5B, the gift-transfer application 412 also includes the digital-gift-input module 418, which may be invoked when a determination is made that a digital gift has not been associated with a unique NFC-tag identifier. The digital-gift-input module 418 allows a user to input a digital gift that is to be associated with the physical gift item by way of the NFC tag. For example, if the gift-transfer application 412 receives a communication from the gift-transfer service 118 indicating that a digital gift has not been associated with the unique NFC-tag identifier, then the digital-gift-input module 418 opens a graphical user interface that allows a digital gift to be selected.

A digital gift can be selected in various manners. For example, the digital-gift-input module 418 may provide an input field into which a user can input a monetary amount. The user may be able to type the amount using a touchscreen keyboard or other type of keyboard. In addition, the mobile device 410 may provide a speech-to-text functionality that allows the user to audibly indicate the monetary amount. In other examples, pre-determined monetary amounts may be presented with selectable buttons (e.g., radio buttons) that allow the user to simply check a box. Other strategies may also be used to allow a monetary amount to be selected or input.

In other examples, the digital-gift-input module 418 may provide a digital-gift online store that allows a user to select a digital gift to be associated with the NFC tag. For example, the digital-gift online store may provide various types of digital media, including videos, images, audio, and the like. In addition, the digital-gift online store may provide the ability to purchase other types of digital gifts, including credits, points, and digital currency.

Once a digital gift has been selected and submitted to the gift-transfer application 412 the digital-gift-input module 418 generates or produces a gift-creating communication 426 (e.g., interprocess communication) that includes the unique NFC-tag identifier and an identification of the digital gift. The communication 426 can then be transmitted to the gift-transfer service 118, which may store a record indicating that the unique NFC-tag identifier is now associated with a digital gift. As described with respect to the communication 422, the digital-gift-input module 418 may generate an electronic communication that did not previously exist, or modify a pre-existing communication, by generating or modifying underlying code 428 constituting the communication 426. The communication 426 specifies both the unique NFC-tag identifier and the digital gift.

Referring now to FIG. 5C, the gift-transfer application 412 also includes the financial-account-selection module 420, which functions as a client-side component of the payment system 130. The financial-account-selection module 420 allows a gift sender to select a financial account to be debited for payment of the digital gift. In addition, the financial-account-selection module 420 allows a gift recipient to select a financial account to be credited when the digital gift includes electronic funds. For example, the gift-transfer service 118 may include its own payment gateway that facilitates payment for the virtual gift. In other examples, the payment system 130 may include a third-party payment system that separately facilitates payment for the digital gift. Examples of third-party payment systems include PayPal®, Samsung® pay, Google® wallet, Apple® pay, and the like. The financial-account-selection module 420 functions as an interface with the payment system 130 to facilitate debit or credit of funds according to the selection of the digital gift.

Once a financial-account identifier has been input, the financial-account-selection module 420 generates or produces a transaction-details communication 430 (e.g., interprocess communication) that includes an identification of the financial account (e.g., account number) as well as transaction details including the amount to be credited or debited. The communication 430 can then be transmitted to the payment system 130 to execute the transaction. As described with respect to the communications 422 and 426, the financial-account-selection module 420 may generate an electronic communication that did not previously exist, or modify a pre-existing communication, by generating or modifying underlying code 432 constituting the communication 430.

The gift-transfer application 412 may include other components as well that allow additional information to be input and communicated to the gift-transfer system. For example, the gift sender may wish to add a security measure to the gift transfer. As such, the gift-transfer application 412 may provide a security-input component that allows the input of a phone number, security answer, or other information that the gift sender may require before the digital gift can be transferred to the gift-recipient mobile device or account. In addition, the gift-transfer application 412 may allow the gift sender to further customize the gift exchange by adding a customized message, image, song, video, and the like. This additional information can be communicated by the gift-transfer application 412 to the gift-transfer service 118 to be stored in association with the unique NFC-tag identifier, such as by using communications similar to communications 422 and 426.

Having described some of the features of the gift-transfer application, reference is now made to FIG. 6 to describe the gift-transfer service 118. As previously mentioned, the gift-transfer service 118 stores information associated with each of the unique NFC-tag identifiers and exchanges information with the gift-transfer application in order to help facilitate transfer of the digital gift. As such, the gift-transfer service includes one or more server computing devices 132 coupled to one or more data-storage devices 134. Although only a single object is drawn to illustratively depict the server 132 and the storage device 134, the server 132 may include a plurality of servers and the storage device 134 may include a plurality of storage devices.

Among other things, the one or more server computing devices 132 function to receive communications from the various copies of the gift-transfer application, to update the information associated with each of the unique NFC-tag identifiers, and to provide information back to the gift-transfer applications. As such, the gift-transfer service 118 maintains a searchable data-store 136 that stores information in association with each unique NFC-tag identifier. Exemplary information that might be maintained in the searchable data-store 136 is illustrated in the magnified view 138. For example, the information that is stored in association with each unique NFC-tag identifier might include an indication of whether a digital gift has been associated with the unique identifier, a monetary value of the digital gift, a link to the digital gift (if appropriate), security information associated with the digital gift, customized messaging to be presented with the digital gift, payment information, payment-transaction details, and the like.

As previously described, the gift-transfer service 118 may receive a tag-query interprocess communication (e.g., element 422 in FIG. 5A) from the gift-transfer application 412, the tag-query interprocess communication including a unique NFC-tag identifier. The server 132 includes a tag-identifier lookup module 140 configured to receive a search query related to a unique NFC-tag identifier and search the data store 136 for data linked to the unique NFC-tag identifier. As such, the server 132 may look up the unique NFC-tag identifier in the searchable data-store 136 to determine whether a digital gift has been associated with the unique NFC-tag identifier. The server 132 may then generate or produce a responsive communication or message that indicates whether the unique NFC-tag identifier is associated with a digital gift and that is sent as a reply to the gift-transfer application that sent the query.

The gift-transfer service 118 may receive the tag-query communication in the context of a gift sender initially scanning the NFC tag or in the context of a gift recipient scanning the NFC tag after receiving the physical gift item. If the unique NFC-tag identifier has not been associated with a digital gift, then the communication generated by the server 132 may indicate such, in which case the gift-transfer application may proceed through the series of steps that allows a digital gift to be associated with the unique NFC-tag identifier using the gift-sender mobile device.

If the unique NFC-tag identifier has been associated with a digital gift, then the communication (e.g., gift-notification interprocess communication 142) generated by the server 132 may also include at least some of the additional information stored in association with the unique NFC-tag identifier. For example, the communication may also indicate the amount of the digital gift, a copy of the digital gift, a link to the digital gift, and any customization details. Or, if the unique NFC-tag identifier is associated with security information, then the communication may request that certain information be verified before the digital gift is transmitted or is allowed to be credited. When generating the gift-notification interprocess communication 142, the tag-identification lookup module 140 may generate an electronic communication that did not previously exist, or modify a pre-existing communication, by generating or modifying underlying code 144 constituting the communication 142.

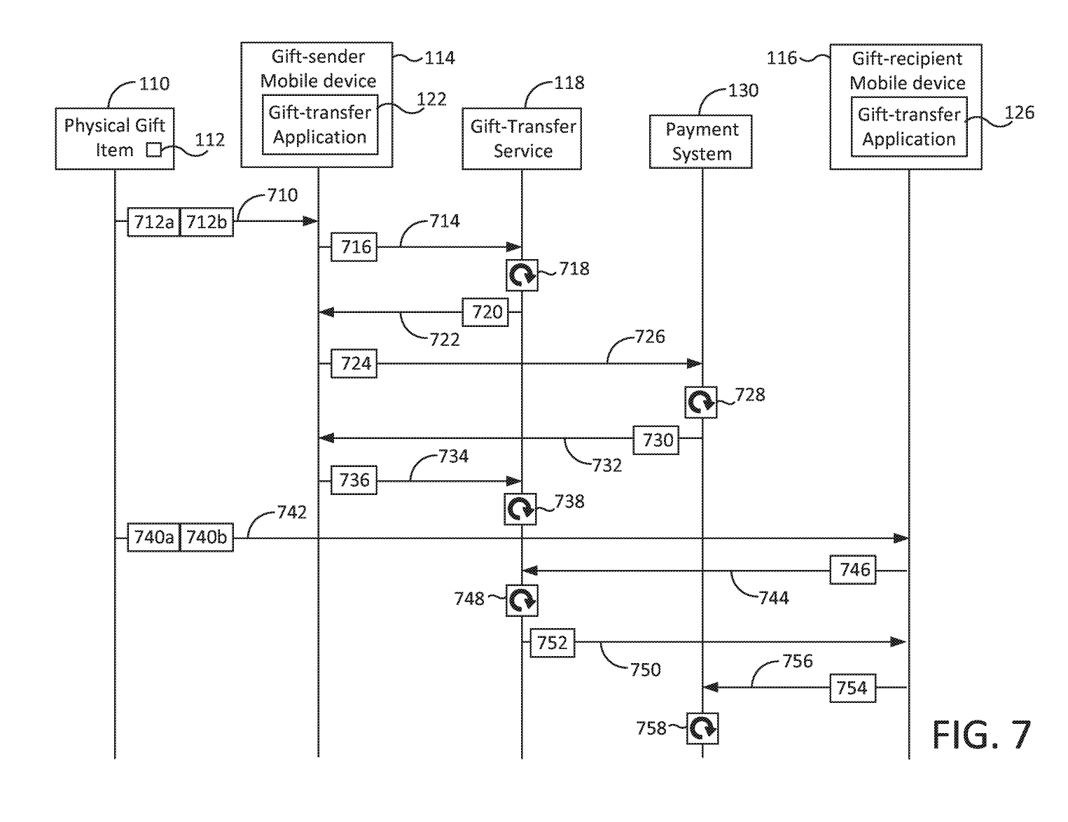

Having described components depicted in FIGS. 1-6, a ping diagram is provided in FIG. 7 to step through some of the operations that might be executed by the physical gift item 110 (including the NFC tag 112), the gift-sender mobile device 114 (including a first copy of the gift-transfer application 122), the gift-transfer service 118, the payment system 130, and the gift-recipient mobile device 116 (including the second copy of the gift-transfer application 126). When describing FIG. 7, reference may also be made to FIGS. 1-6.

At step 710, the NFC tag 112 transmits a unique NFC-tag identifier 712a and computer-executable instructions 712b to the gift-sender mobile device 114, the computer-executable instructions 712b for opening a gift-transfer application on the gift-sender mobile device 114. The gift-sender mobile device 114 opens the first copy of the gift-transfer application 122. As previously described, if the gift-sender mobile device 114 does not includes a copy of the gift-transfer application, then the instructions 712b may direct the gift-sender mobile device to a downloadable version of the gift-transfer application (e.g., at an online application store or at a website). Once open on the gift-sender mobile device 114, the first copy of the gift-transfer application 122 produces a tag-query interprocess communication 714 including the unique NFC-tag identifier. The tag-query interprocess communication 714 is transmitted 716 to the gift-transfer service 118, which looks up 718 the unique NFC-tag identifier in a searchable data-store (e.g., 136) by executing a tag-identifier lookup module. When the gift-transfer service 118 determines that the unique NFC-tag is not associated with a digital gift, the gift-transfer service 118 sends 720 a response communication 722 to the gift-transfer application 122, indicating that the unique NFC-tag identifier is not associated with a digital gift.

Using the gift-sender mobile device 114 and the first copy of the gift-transfer application 122, a digital gift may be selected (e.g., input of monetary amount or selection of digital media or digital experience), and a financial account may be selected to provide payment for the digital gift (e.g., by debiting a selected financial account). The first copy of the gift-transfer application produces a transaction-details interprocess communication 724 that includes a financial-account identifier and an amount to be paid for the digital gift, which is transmitted 726 to the payment system 130. The payment system 130 facilitates 728 payment from the financial account that was selected, and provides 730 payment confirmation 732 to the first copy of the gift-transfer application 122. The first copy of the gift-transfer application 122 may then transmit 734 a gift-creating interprocess communication 736 to the gift-transfer service 118, the gift-creating interprocess communication including at least the unique NFC-tag identifier and an identification of the digital gift. The gift-transfer service 118 may then update 738 the information stored in association with the unique NFC-tag identifier to indicate that the unique NFC-tag identifier is associated with a digital gift. For example, the gift-transfer service 118 may update an existing record that relates to the unique NFC-tag identifier, or may create a new searchable entry that links the unique NFC-tag identifier to the digital gift.

As previously described, a gift sender may give the physical gift item 110 to a gift recipient. Using the gift-recipient mobile device 116, the NFC tag 112 is scanned and the unique NFC-tag identifier 740a and computer-executable instructions 740b are transmitted 742 to the gift-recipient mobile device 116. The gift-recipient mobile device 116 opens the second copy of the gift-transfer application 126 in response to the instructions 740b (or downloads the application 126 if necessary). The second copy of the gift-transfer application 126 may then transmit 744 a tag-query communication 746 to the gift-transfer service 118, the tag-query communication 746 including the unique NFC-tag identifier. The gift-transfer service 118 may perform a look up function 748 by searching its data store for the unique NFC-tag identifier to determine that the unique NFC-tag identifier is associated with the digital gift. The gift-transfer service 118 may transmit 750 a gift-notification interprocess communication 752 to the second copy of the gift-transfer application 126, the gift-notification interprocess communication including a description of the digital gift, as well as any information that helps to retrieve the digital gift, such as a link to the payment system, a copy to digital content, a link to 3^{rd}-party digital content, and the like. Using the gift-recipient mobile device 116 and the second copy of the gift-transfer application 126, a financial account may be selected to receive the credit specified by the digital gift. In turn, the second copy of the gift-transfer application 126 may produce a transaction-details interprocess communication 754 that is transmitted 756 to the payment system 130. The payment system 130 can then facilitate credit 758 of the financial account specified in the transaction-details interprocess communication 754.

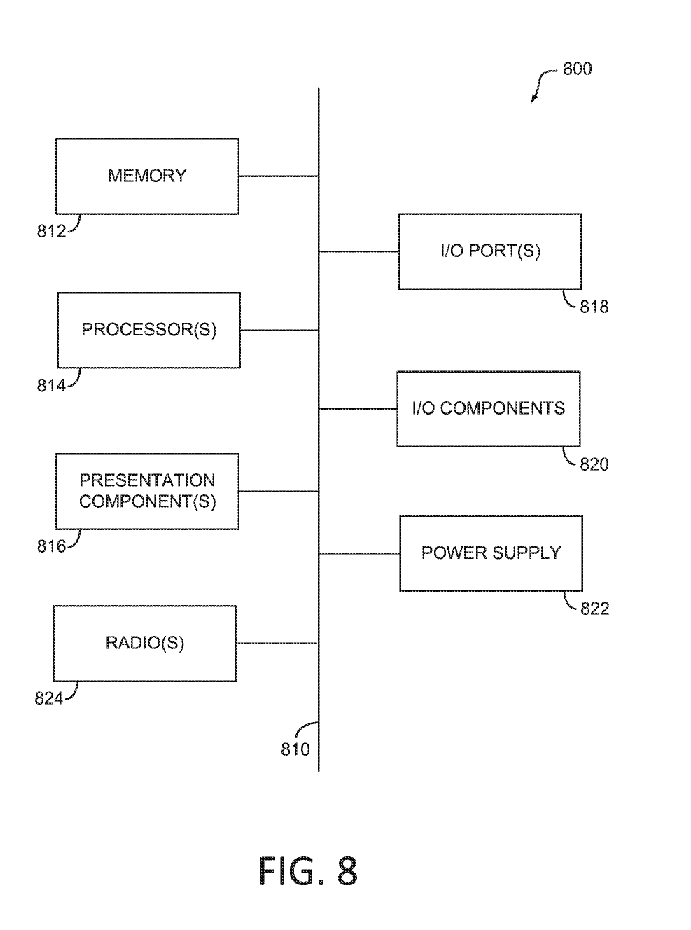

Several of the components described in FIGS. 1-7 include or utilize a computing device. Referring now to FIG. 8, an exemplary operating environment for implementing aspects of the technology described herein is shown and designated generally as a computing device 800. The computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described in this disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, the computing device 800 includes a bus 810 that directly or indirectly couples the following devices: memory 812, one or more processors 814, one or more presentation components 816, input/output (I/O) ports 818, I/O components 820, and an illustrative power supply 822. The bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Such is the nature of the art, and it is reiterated that the diagram of FIG. 8 is merely illustrative of an exemplary computing device that can be used in connection with one or more aspects of the technology described in this disclosure. Distinction is not necessarily made between such categories as “workstation,” “server,” “laptop,” “handheld device,” etc., as all are contemplated within the scope of FIG. 8 and refer to “computer” or “computing device.”

The computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media is different from computer storage media and typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The memory 812 includes computer storage media in the form of volatile and/or nonvolatile memory. The memory 812 may be removable, non-removable, or a combination thereof. Exemplary memory includes solid-state memory, hard drives, optical-disc drives, etc. The computing device 800 includes one or more processors 814 that read data from various entities such as the bus 810, the memory 912, or the I/O components 820. The presentation component(s) 816 present data indications to a user or other device. Exemplary presentation components 816 include a display device, speaker, printing component, vibrating component, etc. The I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. The computing device may include a radio 824. The radio 824 transmits and receives radio communications. The computing device may be a wireless terminal adapted to receive communications and media over various wireless networks. The computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When referring to “short” and “long” types of connections, it is not meant to refer to the spatial relation between two devices. Instead, general reference is made to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection, as well as near-field-communication protocol. A long-range connection may include a connection using one or more of CDMA, GPRS, GSM, TDMA, and 802.16 protocols.

One or more of the computing devices 800 might be used in various capacities in the subject matter described in this disclosure. For example, the mobile computing devices 114, 116, and 410 may include at least some of the components described with respect to the computing device 800. In addition, the server(s) 132, the storage device(s) 134, and the payment system 130 may also include at least some of the components described with respect to the computing device 800. In a further aspect, the various modules (e.g., 416, 418, 420, and 140) may be implemented as a set of computer-readable instructions that utilize a processor to carry out respective operations and to create or modify data, which may be represented by underlying code.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

Claimed are:

1. A gift-transfer system comprising:
a gift item coupled with a near-field-communication tag (NFC tag), the NFC tag being encoded with a unique tag identifier and with computer-executable instructions that, when executed by a computing device, provide computing operations for opening a gift-transfer software application; and
a first copy of the gift-transfer software application that is opened by a first computing device when the computer-executable instructions encoded on the NFC tag are executed by the first computing device, the first copy including a digital-gift-input module,
wherein the digital-gift-input module is programmed to receive an input of a gift amount and to produce a gift-creating interprocess communication specifying the gift amount and the unique tag identifier; and
wherein the gift-creating interprocess communication is sent to a gift-transfer service.

2. The gift-transfer system of claim 1, wherein the first copy of the gift-transfer software application is a mobile-device application, and wherein the computer-executable instructions include a command to open the mobile-device application.

3. The gift-transfer system of claim 1, wherein the first copy of the gift-transfer software application is a web application, and wherein the computer-executable instructions include a command to open a browser and request a website that that provides the web application.

4. The gift-transfer system of claim 1 further comprising, the gift-transfer service configured to receive the gift-creating interprocess communication and to create a searchable data-storage entry linking the unique tag identifier to the gift amount.

5. The gift-transfer system of claim 4 further comprising, a second copy of the gift-transfer software application that is opened by a second computing device when the computer-executable instructions encoded on the NFC tag are executed by the second computing device, the second copy including a tag-status query module, wherein the tag-status query module is programmed to receive an input of the unique tag identifier when the NFC tag is read and to produce a tag-query interprocess communication specifying the unique tag identifier, the tag-query interprocess communication being sent to the gift-transfer service.

6. The gift-transfer system of claim 5, wherein the gift-transfer service includes a tag-identifier lookup module, which determines that the gift amount is associated with the unique tag identifier by searching for the unique tag identifier in the searchable data-storage entry in response to receiving the tag-query interprocess communication, and wherein the gift-transfer service produces a gift-notification interprocess communication that specifies the gift amount and that is sent to the second computing device running the second copy of the gift-transfer software application.

7. The gift-transfer system of claim 6, wherein the first copy of the gift-transfer software application and the second copy of the gift-transfer software application each includes a financial-account-selection module configured to produce interprocess communications that facilitate a transfer of payment by a payment system from a financial account selected using the first copy of the gift-transfer software application to a second financial account selected using the second copy of the gift-transfer software application.

8. The gift-transfer system of claim 7, wherein the financial-account-selection module is configured to receive an input of a financial-account identifier, and wherein the first copy of the gift-transfer software application produces a transaction-details interprocess communication that includes the financial-account identifier and transaction details usable by the payment system to process payment for an amount of the gift amount.

9. The gift-transfer system of claim 7, wherein the financial-account-selection module is configured to receive an input of a financial-account identifier, and wherein the second copy of the gift-transfer software application produces a transaction-details interprocess communication that includes the financial-account identifier and transaction details usable to credit the gift amount to a financial account identified by the financial-account identifier.

10. A gift item comprising:
a gift-item body;
a near-field-communication tag (NFC tag) coupled to the gift-item body; and
a set of encoded data stored on the NFC tag, the set of encoded data including a unique tag identifier and computer-executable instructions that, when executed by a computing device, provide computing operations for opening a gift-transfer software application.

11. The gift item of claim 10, wherein the gift-item body includes a greeting card.

12. The gift item of claim 11, wherein the NFC tag is constructed into at least one panel of the greeting card.

13. The gift item of claim 12, wherein the gift-transfer software application is a mobile-device application, and wherein the computer-executable instructions include a command to open the mobile-device application.

14. The gift item of claim 12, wherein the gift-transfer software application is a web application, and wherein the computer-executable instructions include a command to open a browser and request a website that that provides the web application.

15. A method for transferring a gift, the method comprising:
attaching a near-field-communication tag (NFC tag) to a gift item, wherein the NFC tag is encoded with a unique tag identifier and with computer-executable instructions that, when executed by a computing device, provide computing operations for opening a gift-transfer software application;
launching a first copy of the gift-transfer software application on a first computing device when the first computing device receives the computer-executable instructions from the NFC tag and executes the computer-executable instructions;
receiving by the first copy of the gift-transfer software application the unique tag identifier;
executing by the first copy of the gift-transfer software application a digital-gift-input module;
receiving by the digital-gift-input module an input of a gift amount;
producing by the first copy of the gift-amount-input module a gift-creating interprocess communication specifying the gift amount and the unique tag identifier; and
transmitting the gift-creating interprocess communication to a gift-transfer service.

16. The method of claim 15, wherein the first copy of the gift-transfer software application is a mobile-device application, and wherein launching the mobile-device application includes:
receiving, by the first copy of the gift-transfer software application, an open command, from an operating system of the first computing device; and
opening the first copy of the gift-transfer software application.

17. The method of claim 15, wherein the first copy of the gift-transfer software application is a web application, and wherein launching the web application includes opening the web application in a browser running on the first computing device.

18. The method of claim 15 further comprising,
receiving the gift-creating interprocess communication by the gift-transfer service, and
creating, by the gift-transfer service, a searchable data-storage entry linking the unique tag identifier to the gift amount.

19. The method of claim 18 further comprising,
launching a second copy of the gift-transfer software application on a second computing device when the second computing device receives the computer-executable instructions from the NFC tag and executes the computer-executable instructions;
receiving by the second copy of the gift-transfer software application the unique tag identifier;
executing by the second copy of the gift-transfer software application a tag-status query module;
receiving by the tag-status query module an input of the unique tag identifier;
producing by the second copy of the gift-amount-input module a tag-query interprocess communication specifying the unique tag identifier; and
transmitting the tag-query interprocess communication specifying the unique tag identifier to the gift-transfer service.

20. The method of claim 19 further comprising:
receiving by the gift-transfer service the tag-query interprocess communication, the gift-transfer service including a tag-identifier lookup module;
determining that the gift-amount is associated with the unique tag identifier by executing a lookup function by the tag-identifier lookup module;
producing a gift-notification interprocess communication; and
transmitting the gift-notification interprocess communication to the second computing device.
